(19) United States
(12) Patent Application Publication
(10) Pub. No.: US 2018/0225616 A1
(43) Pub. Date: Aug. 9, 2018

(54) Digital Checklist System Using Mobile Technology, Artificial Intelligence, and Infrared Technology

(71) Applicant: Icarus Ops LLC, Pembroke Pines, FL (US)

(72) Inventors: Joe Dale Jones, Key Largo, FL (US); Gerald Henry Leekey, Pembroke Pines, FL (US); Christopher J. Crosby, JR., Dallas, TX (US); Daya Shankar Ojha, Punjab (IN)

(73) Assignee: Icarus Ops LLC

(21) Appl. No.: 15/424,559

(22) Filed: Feb. 3, 2017

(51) Int. Cl. G06Q 10/06; G06Q 10/04; G06N 3/00

(52) U.S. Cl. CPC G06Q 10/06395; H04M 1/72522; G06N 3/006; G06Q 10/04

(57) ABSTRACT

A digital checklist is presented by a graphical user interface of an on-line application on a display of a mobile computing device. The on-line application communicates and cooperates with an artificial intelligence engine. The artificial intelligence engine reviews data recorded in the digital checklist. The on-line application inserts a date and time stamp for data collected on two or more steps of the digital checklist when the data is recorded. The artificial intelligence engine perform one or more actions based on the date and time stamps for a completed digital checklist. The artificial intelligence engine is coded that when it detects an anomaly, then the artificial intelligence engine is configured to generate a report and communicate that report.

### NOTICE OF COPYRIGHT

A portion of the disclosure of this patent document contains material that is subject to copyright protection. The copyright owner has no objection to the facsimile reproduction by anyone of the interconnect as it appears in the Patent and Trademark Office Patent file or records, but otherwise reserves all copyright rights whatsoever.

### BACKGROUND

Data centers are very much like modern jets when it comes to expense, complexity, redundancy, and the quality of the operators. There can be, however, a sharp contrast in the quality of procedures and checklists used. Many operations lack a tool to harness know how and best practices.

Also, paper procedures are not easily transported to the worksite and are difficult to provide additional reference support. Also, the latest version of the procedure may not be distributed or in use.

### SUMMARY

Various methods and apparatuses are described for a digital checklist presented by a graphical user interface of an on-line application on a display of a mobile computing device. In an embodiment, the on-line application communicates and cooperates with an artificial intelligence engine. The artificial intelligence engine reviews data recorded in the digital checklist. The on-line application inserts a date and time stamp for data collected on two or more steps of the digital checklist when the data is recorded. The artificial intelligence engine is configured to perform one or more actions selected from a group consisting of 1) determining how long a worker took to perform that step compared to an acceptable range based on any of a historical average or an expected average; 2) looking at the data collected to perform trend analysis on a change in data values from the historical records and then make a prediction about maintenance and potential repair of equipment in a building; 3) certifying that critical steps were properly performed in the digital checklist using any of captured photos, videos and quality assurance sign-offs embedded or attached into the data collected in the digital checklist; and 4) checking meta data of attachments to the digital checklist including any of but not limited to photographs, images, and videos, to see if the attachment's time code, indicated in the meta data, matches the time stamp of the steps in which the data was recorded, and 5) ensuring actual completion of each step in the digital checklist is completed prior to giving the indication the digital checklist is complete and can be uploaded. The artificial intelligence engine is coded that when it detects an anomaly, then the artificial intelligence engine is configured to generate a report and communicate that report.

### BRIEF DESCRIPTION OF THE DRAWINGS

The multiple drawings refer to the example embodiments of the invention.

FIG. 1 illustrates a diagram of an embodiment of a digital checklist presented by a graphical user interface of an on-line application on a display of a mobile computing device.

FIG. 2 illustrates a diagram of an embodiment of the graphical user interface that is configured to present a visual icon of a slider bar in the digital checklist requiring deliberate action in order to confirm a particular step of the digital checklist has been completed rather than a tick box that can be accidentally marked by the worker when completing the digital checklist.

FIG. 3 illustrates a diagram of an embodiment of the on-line application being configured to allow authorized users with appropriate permissions per a reference database to create the steps of a new digital checklist.

FIG. 4 illustrates a diagram of an embodiment of the on-line application being configured to allow authorized users with appropriate permissions per the reference database to have a right to change and modify the steps in an existing digital checklist.

FIG. 5 illustrates a diagram of an embodiment of the on-line application that is configured to allow a worker doing the digital checklist to initiate and generate a work order request to repair or schedule maintenance for any problems detected by the worker while doing the steps of the digital checklist on the mobile computing device.

FIG. 6 illustrates a diagram of an embodiment of the on-line application that is configured to force the digital checklist to be performed in sequential step order.

FIG. 7 illustrates a diagram of an embodiment of the on-line application that has code for interoperability with number of different applications as well as multiple operating systems of one or more mobile computing devices in order to request and gather data from a sensor.

FIG. 8 illustrates a diagram of an embodiment of a mobile computing device configured to cooperate the on-line application.

FIG. 9 illustrates a diagram of an embodiment of the on-line application that is coded to communicate and cooperate with an artificial intelligence engine as well as two or more mobile computing devices.

FIGS. 10A-10D illustrate a flow diagram of an embodiment of a method for a digital checklist presented by a graphical user interface of an on-line application on a display of a mobile computing device.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

### DETAILED DISCUSSION

In the following description, numerous specific details are set forth, such as examples of specific steps, named components, connections, etc., in order to provide a thorough understanding of the present invention. It will be apparent, however, to one skilled in the art that the present invention may be practiced without these specific details. In other instances, well known components or methods have not been described in detail but rather in a block diagram in order to avoid unnecessarily obscuring the present invention. Thus, the specific details set forth are merely exemplary. The specific details may be varied from and still be contemplated to be within the spirit and scope of the present invention.

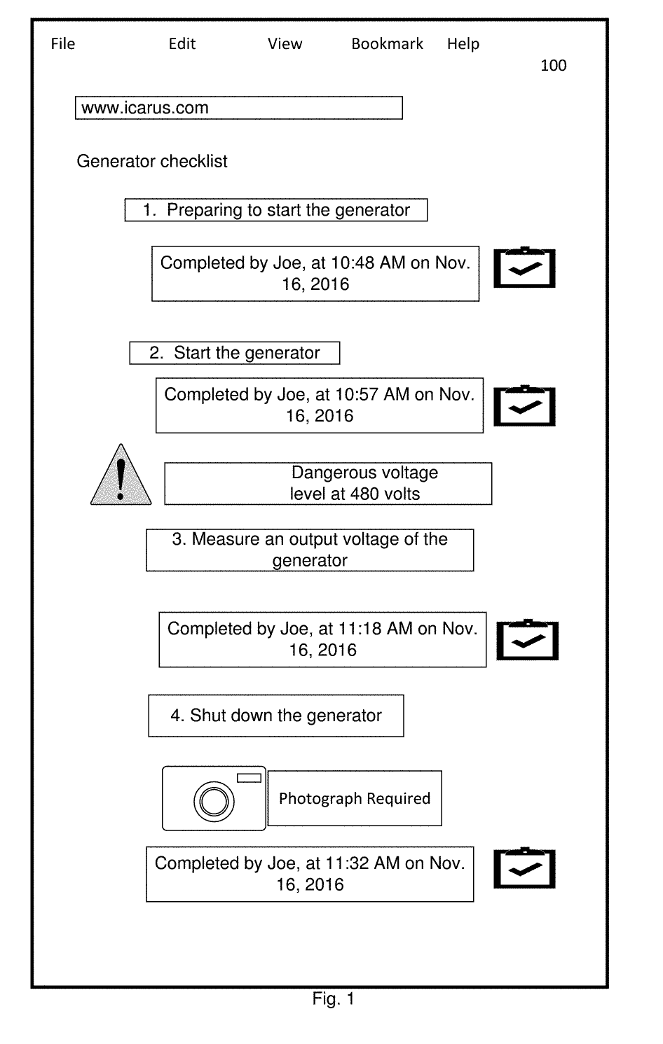

FIG. 1 illustrates a diagram of an embodiment of a digital checklist presented by a graphical user interface of an on-line application on a display of a mobile computing device. The on-line application 100 is coded to insert a date and time stamp for data collected on each step of the digital checklist when the data is recorded. The artificial intelligence engine performs one or more actions of 1) determining how long the worker took to perform that step compared to the acceptable range based on any of the historical average or the expected average; 2) looking at the data collected to perform trend analysis on the change in data values from the historical records and then make the prediction about maintenance and potential repair of equipment in the building; 3) certifying that critical steps were properly performed in the digital checklist using any of captured photos, videos and quality assurance sign-offs embedded or attached into the data collected in the digital checklist; 4) checking meta data of attachments to the checklist including any of but not limited to photographs, images, and videos, to see if the attachment's time code, indicated in the meta data, matches the time stamp of the steps in which the data was recorded; and 5) ensuring actual completion of each step in the digital checklist is completed prior to giving the indication the digital checklist is complete and can be uploaded. The on-line application 100 may be a web enabled application, an application hosted on one or more servers that cooperates with a local application resident on a client device, or another similar application that a user may access over a network.

For example, the digital checklist outlines the steps in the procedure about the diesel generator's checks to be completed by the worker. A first step of the procedure regarding ‘preparing to start the generator’ is completed by the worker, Joe, at 10:48 AM on Nov. 16, 2016. A second step of the procedure about ‘starting the generator’ is completed by the worker, Joe, at 10:57 AM on Nov. 16, 2016. A warning of the procedure regarding a third step on the voltage level being dangerous at 480 volts is acknowledged as being read by the worker, Joe, at 10:58 AM on Nov. 16, 2016. The third step of the procedure ‘measuring an output voltage of the generator’ is completed by the worker, Joe, at 11:18 AM on Nov. 16, 2016. A fourth step of the procedure about ‘shutting down the generator’ is completed by the worker, Joe, at 11:32 AM on Nov. 16, 2016 and requires a photograph to be taken regarding the fuel level indicator and the start switch being left in a standby position.

Data collected on each step of the checklist is recorded with a date and time stamp. This allows an artificial intelligence engine to determine how long the worker took to perform that step. This data can be compared to historical averages as well as expected averages. The artificial intelligence engine also checks out the meta data of attachments to the checklist, such as photographs/images, videos, etc., to see if they match the time stamps of the steps in which the data was recorded. When the artificial intelligence engine detects an anomaly, then the artificial intelligence engine generates a report with potentially the checklist with the anomaly to be sent to a designated person in the company.

The on-line application 100 is coded to communicate and cooperate with an artificial intelligence engine. The artificial intelligence engine is configured to review data recorded in the digital checklist, including, for example, that the steps where completed, who completed the steps, the time stamp of when the step was completed, and the textual, numerical, or other data collected in the steps. In addition, the on-line application 100 has code for interoperability with the one or more mobile applications or the operating system of the mobile computing device to request and gather data from two or more sensors located in mobile computing device and/or in the equipment being maintained. The artificial intelligence engine is configured to analyze data collected from the sensors attached as meta data to any data recorded into the digital checklist by a worker using the mobile computing device. A checklist database is configured to store historical records of previously completed digital checklists. The artificial intelligence engine is coded that when it detects an anomaly, then the artificial intelligence engine is configured to generate a report and communicate that report.

As discussed, the on-line application 100 is coded to certify critical steps using captured photos, videos or quality assurance sign-offs. All data collected in steps, decisions, and acknowledgements in the on-line application 100 are also date/time stamped as they are completed, which leaves an accurate record of what was completed and who completed it. A prior technique from another company is simply to ask the user to sign the procedure in order to certify it was properly completed. Data can also include captured photos or short videos at critical points in the digital checklist to document a proper task accomplishment.

Note, a digital checklist that can include a procedure system (from here on forward we will only use “checklist”, but the term includes both. The digital checklist may be created and utilized for operations of mission-critical facilities and/or equipment: data centers, oil production and drilling facilities, critical maintenance and operations teams for complex machines and evolutions, including space flight, drones, aircraft, ships, trains, autonomous vehicles, manufacturing, power generation, etc. The on-line application 100 is coded to be useful in an environment where processes must be completed repeatedly and without error and when a company is required to prove that these processes were properly completed.

The digital checklist, including potentially a set of procedures, may use a local mobile application that cooperates with the on-line application 100 to present the digital checklists on a mobile device, such as an Android or Apple tablet, Google Glass, etc.

The on-line application 100 and the local mobile app are coded so that each digital checklist step, warning, and decision is date/time stamped by the mobile device and then the data is stored locally until the completed checklist is ready for upload to the backend server. The on-line application 100 cooperating with the artificial intelligence engine implementing the digital checklist reduces the reasons for failure to comply with procedures. A mobile computing device running the local mobile app and the on-line application 100 are easily transported to the worksite. This combination provides easy reference to the steps of the procedure as well as access to secondary materials of tutorials and guidance to assist in the proper performance of the steps of the procedure.

The interactive digital checklists track and time stamp activities, enabling audit-friendly records while ensuring that human error is reduced dramatically.

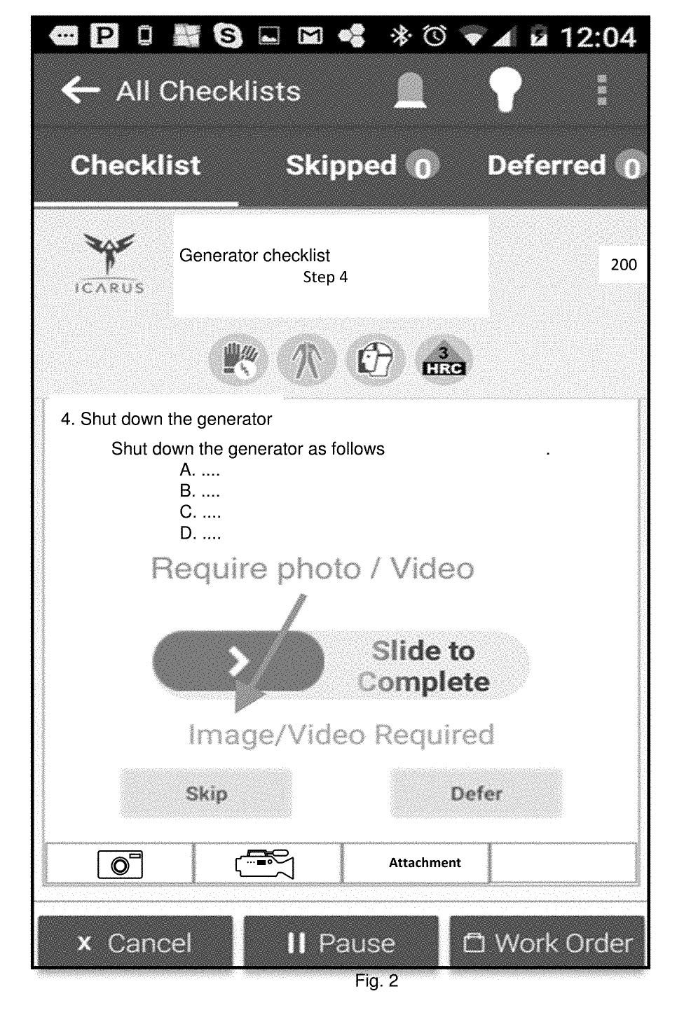

FIG. 2 illustrates a diagram of an embodiment of the graphical user interface that is configured to present a visual icon of a slider bar in the digital checklist requiring deliberate action in order to confirm a particular step of the digital checklist has been completed rather than a tick box that can be accidentally marked by the worker when completing the digital checklist; and thus, mitigate a chance of accidentally marking that step as complete when it actually is not.

The on-line application 200 shows a tab for checklists, steps skipped, and steps deferred. The on-line application 200 indicates that the current step in the checklist is, for example, shutting down the generator. Part of completing this step by the worker requires a photograph to be taken regarding the fuel level indicator and the start switch being left in a standby position. After the photograph is taken, the worker is required to take the positive action of moving the visual icon of a slider bar from left to right.

The visual icon of a slider bar requires deliberate action in order to confirm a step of the digital checklist has been completed rather than a tick box that can be accidentally marked. The visual slider step to indicate a completed step ensures a deliberate action to complete the step in order to mitigate the chance of accidentally marking a step complete.

The on-line application 200 implementing the digital checklist allows a proper completion of medium to high-risk operations. The on-line application 200 implementing the digital checklist helps users do things properly, drives compliance with built-in oversight by cooperating with the artificial intelligence engine, and generates provable reports for leadership and auditing review.

The on-line application 200 allows 100% verifiable compliance of execution of the steps and data within the steps.

Note, initially the user can initiate the on-line application 200 by typing in the Universal Resource Locator such (as www.icarus.com see FIG. 1) or by launching the local mobile app on the mobile computing device to initiate and communicate with the on-line application 200. The on-line application 200 authenticates the user with the system and obtains the user information via, for example, a get command. The on-line application 200 via its application-programming-interface facilitates a fetch command to retrieve the authorized client users and/or authorized user groups. In general, authorization is sent with all requests. The authorization helps the server to validate the request source. The on-line application 200 will present icons, a drop down menu, and/or a search bar to allow the user to choose a specific type of checklist they would like to have presented on the display screen. The on-line application 200 via the application-programming-interface facilitates a fetch command to retrieve merely the type of checklists indicated by the user. This allows the on-line application 200 to quickly find and display the desired procedure/checklist. The application-programming-interface will call and fetch checklists with similar titles as well as checklist in the similar technology area. The user then can select the one they wish to be launched and presented on the display screen. Similarly, when a user clicks on a potential hazards icon in the checklist, the application-programming-interface facilitates a fetch command to retrieve the associated hazards recorded for this checklist. When a user clicks on a PPE icon in the checklist, the application-programming-interface facilitates a fetch command to retrieve the personal protective equipment recorded for this checklist.

The on-line application 200 is coded to allow a company, such as a data center operator, to convert facility documentation and best practices from traditional paper documents into actionable, interactive digital checklists. The operational documentation checklists are presented by a user interface of the software app designed specifically for display on the wearable visor tech and/or on the display screen of a mobile computing device, such as a tablet. For example, a data center worker interacts with the digital checklists via the wearable technology, turning that employee into a walking, talking encyclopedia of knowledge about the facility. Thus, in an embodiment, the on-line application 200 is coded with a user interface to specifically cooperate with mobile technology to present the digital checklists and its procedures to technicians via tablets and wearable devices such as Google Glass and/or a smart watch. Note a ‘mobile computing device’ includes tablets and other wearable devices. A company may outfit data center workers with a combination of high-tech visors and other key technology that steers them through maintenance and other standard operating procedures. The on-line application 200 links mobile and wearable technology together.

A reference database in communication with the on-line application 200 houses user data and permissions. A checklist database the indexes, stores, and archives the population of digital checklists. The on-line application 200 has a digital checklist writing module that assist in composing the digital checklist and various updating tools for modifying and updating the version of the digital checklist.

The on-line application 200 utilizing the artificial intelligence engine analyzes any completed digital checklists to ensure they were performed within normal parameters.

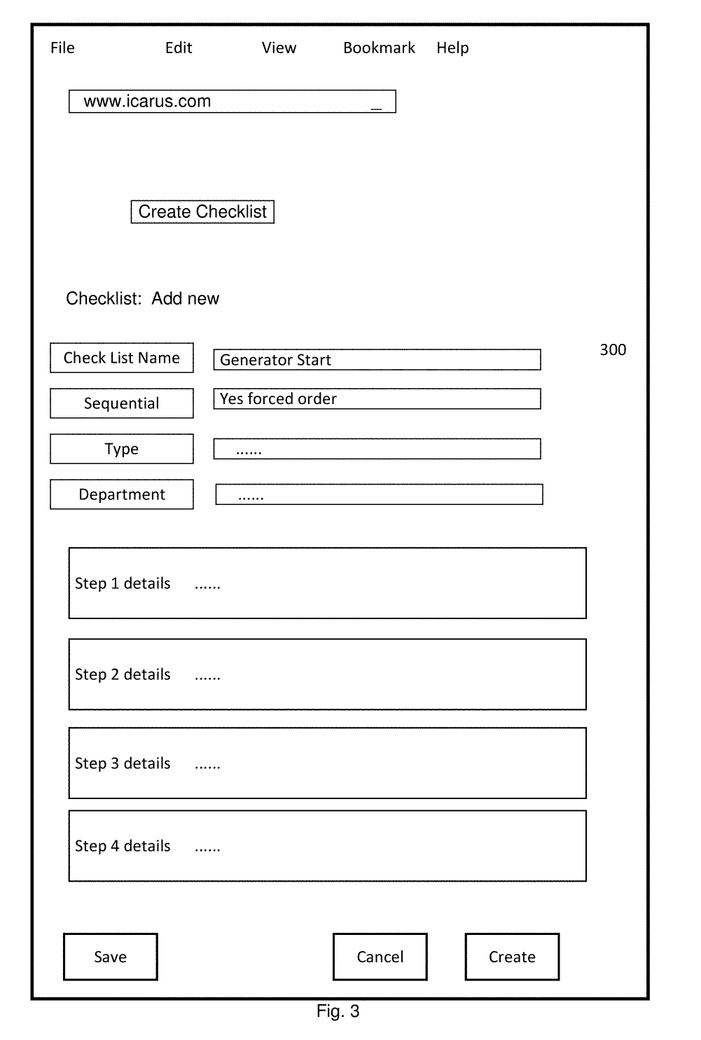

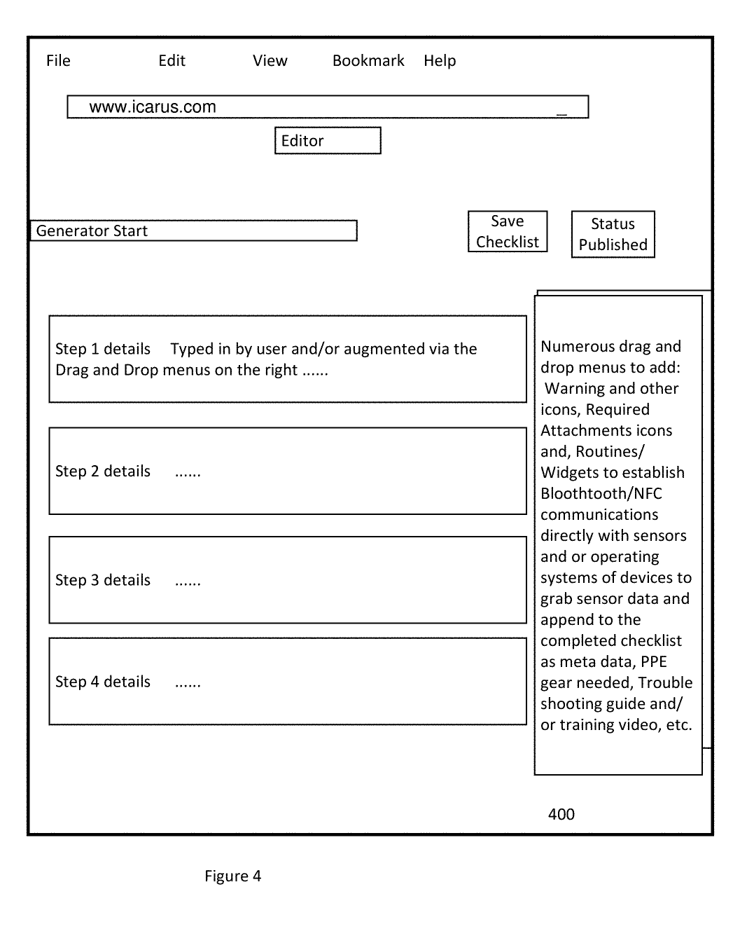

FIGS. 3 and 4 illustrate a diagram of an embodiment of the on-line application being configured to allow authorized users with appropriate permissions per a reference database to both 1) to create the steps of the digital checklist, as well as 2) to also have a right to change and modify the steps in that digital checklist. The authorized users can then save and publish a version of the digital checklist. The on-line application allows user customization of digital checklists in its steps, notifications, data collection, when and how verification occurs, etc.

FIG. 3 illustrates a diagram of an embodiment of the on-line application 300 being configured to allow authorized users with appropriate permissions per a reference database to create the steps of a new digital checklist.

FIG. 4 illustrates a diagram of an embodiment of the on-line application 400 being configured to allow authorized users with appropriate permissions per the reference database to have a right to change and modify the steps in an existing digital checklist, who can then save and publish a version of the digital checklist. The authorized users register with the on-line application 300, 400 may register and check their permissions.

When creating and modifying checklists, many example commands can be added onto the graphical user interface. For example, a create checklists icon can be added onto the graphical user interface. The name, sequence steps, details of the step to be type, etc. can all be added. A checklist icon to call up an index of all existing checklists can be added the user interface.

Accordingly, the authorized user may activate a checklist icon to call up existing checklists or add a new checklist. The authorized user may then activate an add checklist icon to create a new checklist. The authorized user may then fill out various fields to give a name to the checklist, sequence steps, details of the step to be type, etc. A ‘Capture Data’ command allows text input (e.g. part serial numbers, equipment readings, etc.) to be saved. Various fields have arrow drop downs of “Pass/Fail” and “Yes/No” to offer choices based on criteria presented (i.e. a test to be performed or question to be answered). “Attachment required” allows a photo or photos to be captured using the mobile computing device's built in camera and uploaded using the on-line application. When completing a step with “File required” using the web app, any file type can be uploaded.

The on-line application 300 allows creation of different checklist types in the level of detail contained in each steps, how to verify, and the number of steps included in each checklist. The on-line application 300, 400 can populate warnings, steps, etc. from multiple tables/databases, such as 78 different tables each corresponding to different category, in the database to allow user to create steps and different conditions to check for in steps and alarms warnings, training videos, images, comments, to insert into the steps of the checklist. Thus, for each step, the step's details are typed in by user and then augmented via the Drag and Drop menus. Numerous drag and drop menus exist to add functionality into a given step of the digital checklist. For example, drag and drop menus add: Warning and other icons, Required Attachments icons, Routines/Widgets to, for example, establish Bluetooth or NFC communications directly with sensors and/or operating systems of devices to grab sensor data and append that data to the completed checklist as meta data, PPE gear needed, Trouble shooting guide and/or training video, etc.

The on-line application 300, 400 also allows creation of and embedding a video, animations, hyperlinks to external videos and documents, or photos for complex operations.

The users can also save and publish the checklists. Thus, the user can save the digital checklist as well as publish a finalized digital checklist. The on-line application 400 ensures that the latest version of the checklist/procedure in the checklist database is always the one in use.

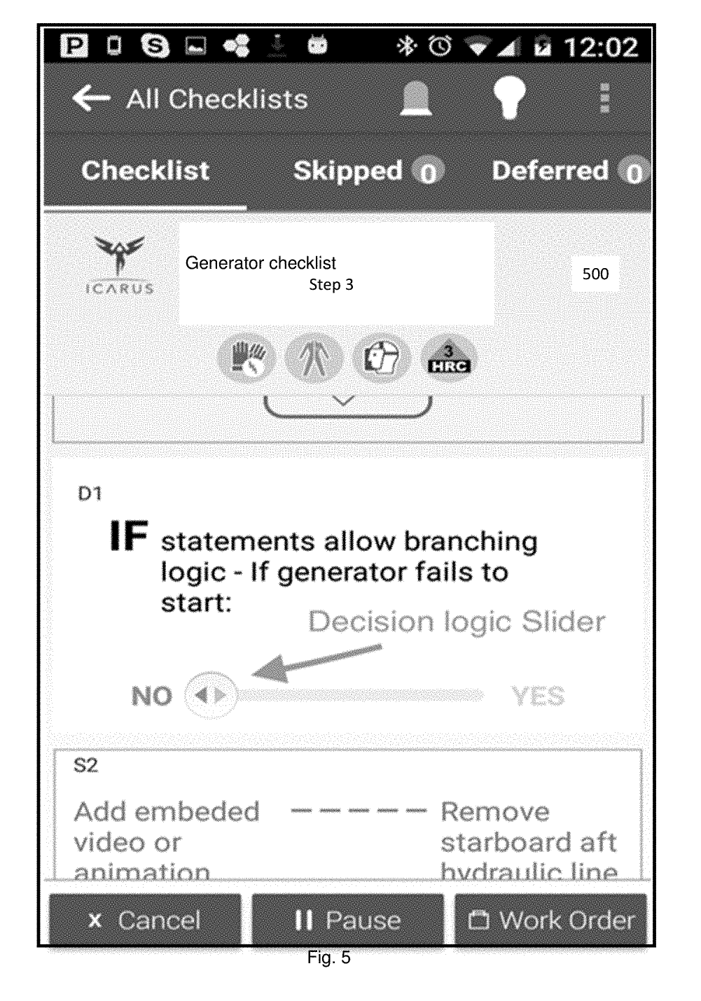

FIG. 5 illustrates a diagram of an embodiment of the on-line application that is configured to allow a worker doing the digital checklist to initiate and generate a work order request to repair or schedule maintenance for any problems detected by the worker while doing the steps of the digital checklist on the mobile computing device.

The on-line application 500 on the mobile computing device has icon or other tab built in for a link to launch a work order system executable file, which allows operators to easily enter in a textual description to identify any problems and include a still picture, video, or Infrared (IR) picture to the work order. The on-line application 500 then allows uploading and routing of the work order to a designated person in the company.

The on-line application 500 is also coded to allow critical lessons from workers in the field to be learned and incorporated via a feedback mechanism. A user can make a suggestion on a mobile device via the on-line application 500. The suggestion is routed to go to an approving authority. The suggested change can be made by the user with the appropriate permissions per FIG. 4 to modify an existing digital checklist. Next, any new revisions to a digital checklist will then be pushed instantaneously to all of the mobile computing devices each having its own instance of a local mobile application cooperating with the on-line application 500. In addition, if multiple facility locations are using similar procedures, the new revisions of the digital checklist are pushed to a database associated with that facility. The suggestion icon in the on-line application 500 easily and instantly captures suggestions for continuous improvement from the workers doing the job.

Next, one or more of the steps in the checklist may be a conditional statement. For example, is the output voltage greater than 400 volts? The on-line application 500 may make use of visual Yes or No slider bar for branching logic.

Also, the on-line application 500 is coded to call up and present on the display of the mobile computing device any of an appropriate trouble shooting guide or a training video from a reference database cooperating with the artificial intelligence engine 1) when an abnormal situation is indicated by the worker via any icon or field in the graphical user interface as well as 2) when the artificial intelligence engine determines that abnormal data has been collected. When the user does the appropriate action for the abnormal situation, the system will understand that the worker accomplished that step, via feedback from the machine or system, and then automatically report the step and completed data in the digital checklist to a designated person at the company.

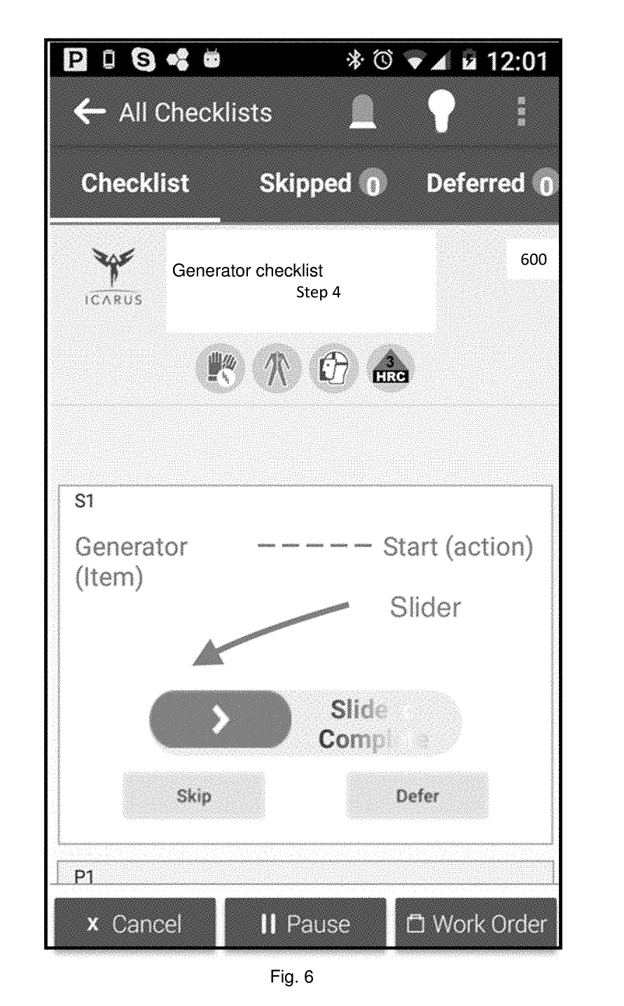

FIG. 6 illustrates a diagram of an embodiment of the on-line application that is configured to force the digital checklist to be performed in sequential step order. The on-line application only allows a worker to skip a forced sequential step out of order when the worker takes a positive action of asking to skip this step and then enters in an explanation into a field of the graphical user interface of why the worker is performing that step out of sequential step order. Thus, the user can perform that step out of order from its appearance in the checklist but must explain why. Then at the end, a completion check routine ensures all steps have been completed before the completed checklist is indicated as ready for upload.

The digital checklist and on-line application 600 have a forced sequential step flow checklist when that checklist is created or modified via the forced sequential field. When selected as a condition in the sequence field for that checklist, then the worker is only allowed to skip a forced step when they take positive action of asking to skip this step and then put in an explanation of why they are skipping that step on the checklist. The worker can perform that step out of order from its appearance in the checklist but must explain why. At the end of all the steps, the completion check routine ensure all steps have been completed before the completed checklist is indicated as ready for upload.

Thus, the on-line application 600 and mobile app are coded so that digital checklists steps cannot be accidental skipped. The on-line application 600 and/or local mobile application will alert the user if they try to execute the steps out of any required sequential order, or fail to acknowledge warnings, cautions, or notes, or if they miss a decision point.

In an embodiment, the digital checklist incorporates logic in its step flow that forces sequential compliance and warns the user if a step is accidentally missed. Forced sequential logic means the user is informed immediately if a step is skipped. As shown, the options to “Skip” and/or “Defer” are included but require the worker to both activate a slider bar and to justify why a step is skipped or deferred. This eliminates the need to potentially falsify steps in order to complete subsequent steps when a step cannot be performed in order and avoids accidently skipping a step. All of these innovations help the on-line application 600 utilizing a mobile computing device to reduce human error for mission critical operations.

Note, as previously discussed, the artificial intelligence engine analyzes data in the digital checklist to check the compliance of that data to expected values for each field expecting data and/or attachments that workers are supposed to record. In addition, the artificial intelligence engine also checks the worker actually performed the step and that the appropriate steps were performed in the sequential checklist order. If any of the above is not adhered to, the artificial intelligence engine generates a report to the designated group or person in the company to bring this deviation to their attention.

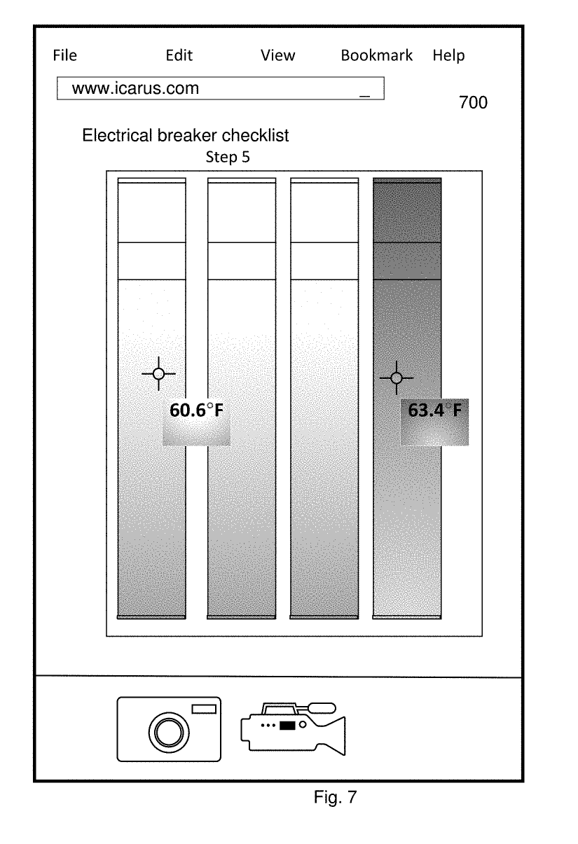

FIG. 7 illustrates a diagram of an embodiment of the on-line application that has code for interoperability with number of different applications as well as multiple operating systems of one or more mobile computing devices in order to request and gather data from a sensor, such as an Infrared camera, located in the mobile computing device or communicating with the mobile computing device. In this case, the artificial intelligence engine is configured to analyze the data from the Infrared camera to look for thermal anomalies that identify potential problems in equipment. The thermal anomalies include but are not limited to 1) thermal runaway in batteries, 2) excess heat from loose terminal connections in switchgear, which produce vibrations and heat indicating probable failure, 3) similar pieces of equipment operating in close proximity to each other but operating at different operating temperatures, and 4) similar thermal issues that can be measured/observed with the Infrared camera. The artificial intelligence engine is configured to analyze data collected from the sensors as meta data attached to any data recorded into the digital checklist by the worker using the mobile computing device.

FIG. 7 illustrates an image of multiple electrical breaker cabinets showing the gradients of temperatures across the set of electrical breaker cabinets. The temperature differences and absolute temperature across the images are stored as metadata as well as potentially the IR image itself. The on-line application 700 is coded to communicate with one or more Infra-Red (IR) camera sensors to collect and gather data directly from this sensor to identify potential problems. The Infrared Technology (IR) wearable device technology allows detection of equipment problems through thermal temperatures, including temperature differences and absolute temperature. The on-line application 700 has coded routines to communicate this data to the intelligence engine. The on-line application 700 can then present the analysis utilizing an attached IR camera to a mobile device in order to look for thermal anomalies including overheating components or change in temperature of equipment. This helps identify equipment problems before expensive failures occur. The IR wearable technology connects with the mobile device running a browser app or has a local partner app resident on the device that cooperates with the on-line application 700 and is configured to accept and analyze thermal image files. For example, the IR wearable technology can detect bad batteries that need more current to charge and have thermal run away. The IR wearable technology can detect improperly torqued high voltage connections that have vibrations and thermal hot spots. The IR wearable technology can detect similar pieces of equipment operating in close proximity to each other like the electrical breaker cabinets but operating at different operating temperatures, such as three cabinets operating at 60.6 degrees F. and a fourth cabinet operating at 63.4 degrees F. Avoidance of expensive failures through the use of IR technology within the digital checklist system is another valuable benefit. This technological feature allows the capture of video and images of previously invisible problems before they cause failures.

The artificial intelligence engine uses IR technology to look for potential trouble in facilities to mitigate risk. During daily rounds or even periodic digital checklists, the digital checklist system will require a technician to take IR photos and or videos of critical equipment. This new data will then be compared to existing data to look for increased temperatures indicating potential future failures. These IR photos and videos are captured within the digital checklist or added to a “Work Order” to have the identified problem corrected.

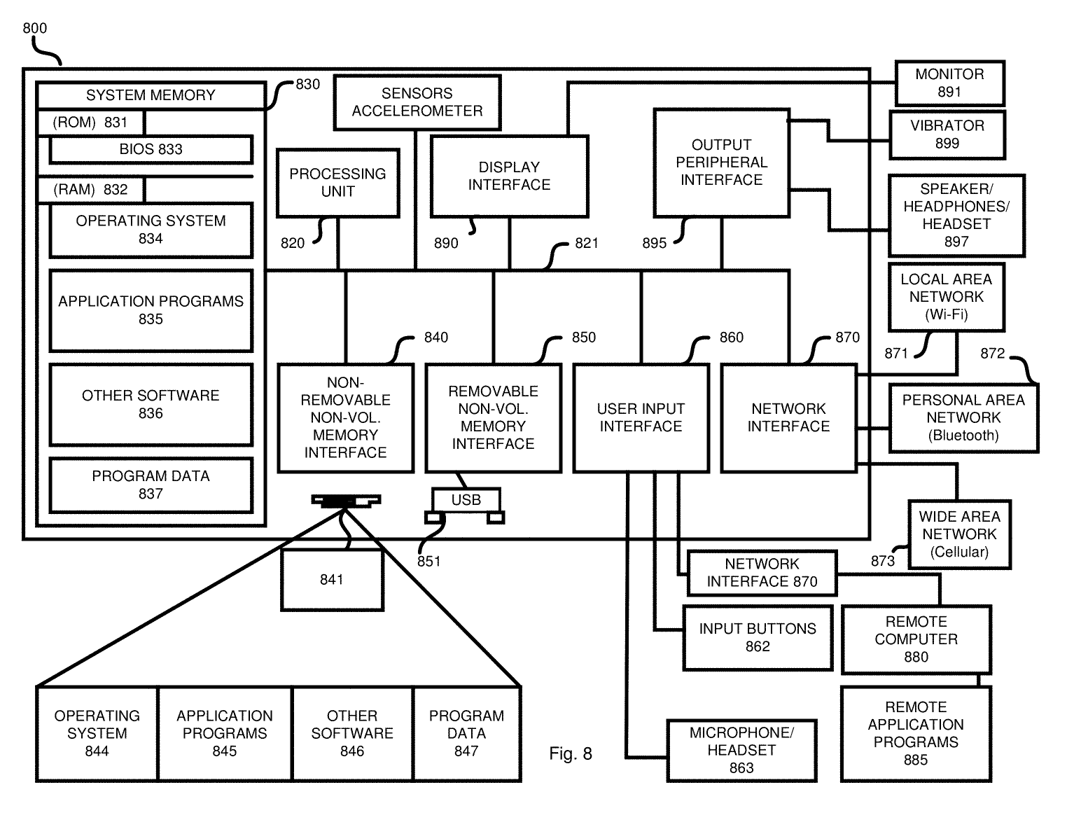

FIG. 8 illustrates a diagram of an embodiment of a mobile computing device configured to cooperate the on-line application. The on-line application is coded for interoperability with one or more applications or operating system of the mobile computing device to request and gather data from one or more sensors selected from a group consisting of a Global Positioning System, an Infrared camera, a temperature sensor, and an altitude sensor, located in the mobile computing device or in communication with the mobile computing device

The on-line application has coded in interoperability to work with and gather data from a number of different sensors such as GPS, IR, temperature sensors, altitude sensors, and other sensory functions found in across a broad spectrum of wearable devices. The on-line application has built-in code to directly interact with machines to gather data from these sensors.

Again, the artificial intelligence engine analyzes the data collected from the sensors as meta data attached to the data recorded into the checklist by the worker. For example, if the mobile computing device has GPS capability, the GPS location of the worker may be recorded at that same time of when the data for a step is collected to ensure that the worker is approximately in the same location as where the data is supposed to be collected and verified by the worker. Also, for example, if a step in a digital checklist calls for starting the generator, the on-line application issues a fetch command to communicate with the control system or even a smart sensor to get a response signal that the generator has started. The worker can then advance to the next step. Likewise, an RFID sensor placed on various equipment and with the technician can be used to ensure a technician is in the proper location for the check. Both sensors to detect the technician actual location when the data is being recorded in the checklist is a way of Geo fencing the data at the time it was actually recorded. The comparison for Geo fencing may create an immediate feedback, such as a pop up window warning that the location is incorrect, to the technician to prevent an error. For example, the pop up window warns a technician that they cannot run a “power center A” checklist when that technician is actually physical located in “power center B” thereby preventing errors.

In addition, the on-line application is configured to have a cooperating portion that is stored as a local mobile application resident on the mobile computing device. The local mobile application resident on the mobile computing device is configured to communicate through a Wi-Fi circuit in the mobile computing device to communicate with the on-line application.

An embodiment of the local mobile application is configured with enough functionality and stored instances of different checklists to allow the data collection and calling up of the appropriate one or more checklists from a set of locally stored checklists to work offline with no internet required to execute and record the data of the one or more checklists. The on-line application has coded routines and stored checklists in a database to feature complete offline capability for tablets and wearable devices, when these devices are not connected to a Wi-Fi source. The user on mobile device can always get to checklist and have data collected stored locally in the mobile device. The digital checklist includes a set of procedures and a set of guidelines and tips on performing the procedures stored locally on the mobile computing device associated with each given checklist. The cooperating local mobile app is also coded so that each digital checklist step, warning, and completion of a step is date and time stamped by the mobile computing device and then the data collected is stored locally until the digital checklist with all of its steps completed is ready for upload to a backend server and database associated with the artificial intelligence engine.

Note, all of the information from the on-line application and the local mobile app for the mobile devices periodically synchronizes at regular intervals in both directions when Wi-Fi is available. The local mobile app cooperates with the on-line application to upload a given digital checklist with an indication that it is finished when the all of the steps of that digital checklist are complete. The completion routine assists in ensuring the completion of the digital checklist.

1) The on-line application providing digital checklists and 2) the artificial intelligence engine's oversight use interactive checklists, wearable technology, and standardized procedures to trap errors, while increasing overall compliance and performance. The system's job is to make it easy to correctly accomplish routine tasks and foreseeable emergencies with verifiable compliance.

Components on the computing device 800 may include one or more processors 820 to execute instructions, one or more memories 830-832 to store information, one or more data input components 860-863 to receive data input from a user of the computing device 800, one or more modules that include the on-line application, a network interface communication circuit 870 to establish a communication link to communicate with other computing devices external to the mobile computing device, one or more sensors where an output from the sensors is used for sensing a specific triggering condition and then correspondingly generating one or more preprogrammed actions, a display screen 891 to display at least some of the information stored in the one or more memories 830-832 and other components. Note, portions of the on-line application and the local mobile app implemented in software 844, 845, 846 may be stored in the one or more memories 830-832 and are executed by the one or more processors 820.

Components of the computing system 800 may include, but are not limited to, a processing unit 820 having one or more processing cores, a system memory 830, and a system bus 821 that couples various system components including the system memory 830 to the processing unit 820. The system bus 821 may be any of several types of bus structures selected from a memory bus, an interconnect fabric, a peripheral bus, and a local bus using any of a variety of bus architectures.

Computing system 800 typically includes a variety of computing machine-readable media. Computing machine-readable media can be any available media that can be accessed by computing system 800 and includes both volatile and nonvolatile media, and removable and non-removable media. By way of example, and not limitation, computing machine-readable media use includes storage of information, such as computer-readable instructions, data structures, other executable software, or other data. Computer-storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information and which can be accessed by the computing device 800. Transitory media such as wireless channels are not included in the machine-readable media. Communication media typically embody computer readable instructions, data structures, other executable software, or other transport mechanism and includes any information delivery media.

The system memory 830 includes computer storage media in the form of volatile and/or nonvolatile memory such as read only memory (ROM) 831 and random access memory (RAM) 832. A basic input/output system 833 (BIOS) containing the basic routines that help to transfer information between elements within the computing system 800, such as during start-up, is typically stored in ROM 831. RAM 832 typically contains data and/or software that are immediately accessible to and/or presently being operated on by the processing unit 820. By way of example, and not limitation, FIG. 8 illustrates that RAM 832 can include a portion of the operating system 834, application programs 835, other executable software 836, and program data 837.

The computing system 800 can also include other removable/non-removable volatile/nonvolatile computer storage media. By way of example only, FIG. 8 illustrates a solid-state memory 841. Other removable/non-removable, volatile/nonvolatile computer storage media that can be used in the example operating environment include, but are not limited to, USB drives and devices, flash memory cards, solid state RAM, solid state ROM, and the like. The solid-state memory 841 is typically connected to the system bus 821 through a non-removable memory interface such as interface 840, and USB drive 851 is typically connected to the system bus 821 by a removable memory interface, such as interface 850.

The drives and their associated computer storage media discussed above and illustrated in FIG. 8, provide storage of computer readable instructions, data structures, other executable software, and other data for the computing system 800. In FIG. 8, for example, the solid-state memory 841 is illustrated for storing operating system 844, application programs 845, other executable software 846, and program data 847. Note that these components can either be the same as or different from operating system 834, application programs 835, other executable software 836, and program data 837. Operating system 844, application programs 845, other executable software 846, and program data 847 are given different numbers here to illustrate that, at a minimum, they are different copies.

A user may enter commands and information into the computing system 800 through input devices such as a keyboard, touchscreen, or software or hardware input buttons 862, a microphone 863, a pointing device and/or scrolling input component, such as a mouse, trackball or touch pad. The microphone 863 can cooperate with speech recognition software. These and other input devices are often connected to the processing unit 820 through a user input interface 860 that is coupled to the system bus 821, but can be connected by other interface and bus structures, such as a parallel port, game port, or a universal serial bus (USB). A display monitor 891 or other type of display screen device is also connected to the system bus 821 via an interface, such as a display interface 890. In addition to the monitor 891, computing devices may also include other peripheral output devices such as speakers 897, a vibrator 899, and other output devices, which may be connected through an output peripheral interface 895.

The computing system 800 can operate in a networked environment using logical connections to one or more remote computers/client devices, such as a remote computing system 880. The remote computing system 880 can a personal computer, a mobile computing device, a server, a router, a network PC, a peer device or other common network node, and typically includes many or all of the elements described above relative to the computing system 800. The logical connections depicted in FIG. 8 can include a personal area network (PAN) 872 (e.g., Bluetooth®), a local area network (LAN) 871 (e.g., Wi-Fi), and a wide area network (WAN) 873 (e.g., cellular network), but may also include other networks such as a personal area network (e.g., Bluetooth®). Such networking environments are commonplace in offices, enterprise-wide computer networks, intranets and the Internet. A browser application may be resident on the computing device and stored in the memory.

When used in a LAN networking environment, the computing system 800 is connected to the LAN 871 through a network interface 870, which can be, for example, a Bluetooth® or Wi-Fi adapter. When used in a WAN networking environment (e.g., Internet), the computing system 800 typically includes some means for establishing communications over the WAN 873. With respect to mobile telecommunication technologies, for example, a radio interface, which can be internal or external, can be connected to the system bus 821 via the network interface 870, or other appropriate mechanism. In a networked environment, other software depicted relative to the computing system 800, or portions thereof, may be stored in the remote memory storage device. By way of example, and not limitation, FIG. 8 illustrates remote application programs 885 as residing on remote computing device 880. It will be appreciated that the network connections shown are examples and other means of establishing a communications link between the computing devices that may be used.

As discussed, the computing system 800 can include a processing unit 820, a memory (e.g., ROM 831, RAM 832, etc.), a built in battery to power the computing device, an AC power input to charge the battery, a display screen, a built-in Wi-Fi circuitry to wirelessly communicate with a remote computing device connected to network.

It should be noted that the present design can be carried out on a computing system such as that described with respect to FIG. 8. However, the present design can be carried out on a server, a computing device devoted to message handling, or on a distributed system in which different portions of the present design are carried out on different parts of the distributed computing system.

Another device that may be coupled to bus 821 is a power supply such as a DC power supply (e.g., battery) or an AC adapter circuit. As discussed above, the DC power supply may be a battery, a fuel cell, or similar DC power source that needs to be recharged on a periodic basis. A wireless communication module can employ a Wireless Application Protocol to establish a wireless communication channel. The wireless communication module can implement a wireless networking standard.

In some embodiments, software used to facilitate algorithms discussed herein can be embodied onto a non-transitory machine-readable medium. A machine-readable medium includes any mechanism that stores information in a form readable by a machine (e.g., a computer). For example, a non-transitory machine-readable medium can include read only memory (ROM); random access memory (RAM); magnetic disk storage media; optical storage media; flash memory devices; Digital Versatile Disc (DVD's), EPROMs, EEPROMs, FLASH memory, magnetic or optical cards, or any type of media suitable for storing electronic instructions.

Note, an application described herein includes but is not limited to software applications, mobile apps, and programs that are part of an operating system application. Some portions of this description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as C, C+, HTTP, Java, or other similar languages. Also, an algorithm can be implemented with lines of code in software, configured logic gates in software, or a combination of both. In an embodiment, the logic consists of electronic circuits that follow the rules of Boolean Logic, software that contain patterns of instructions, or any combination of both.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

Many functions performed by electronic hardware components can be duplicated by software emulation. Thus, a software program written to accomplish those same functions can emulate the functionality of the hardware components in input-output circuitry. Thus, provided herein are one or more non-transitory machine-readable medium configured to store instructions and data that when executed by one or more processors on the computing device of the foregoing system, causes the computing device to perform the operations outlined as described herein.

The on-line application 200 is coded to display leadership dashboards in map, lists, and calendar view formats to show digital checklist completion data, work orders and suggestions for improvement.

A web-based management console on the on-line application 200 will allow a customer to view a status of work being conducted, manage assignments of workers, and incorporate that information into other systems.

The on-line application 200 is also coded to display overdue, pending, and complete digital checklist, including a group of digital checklists that are due in the selected period of time.

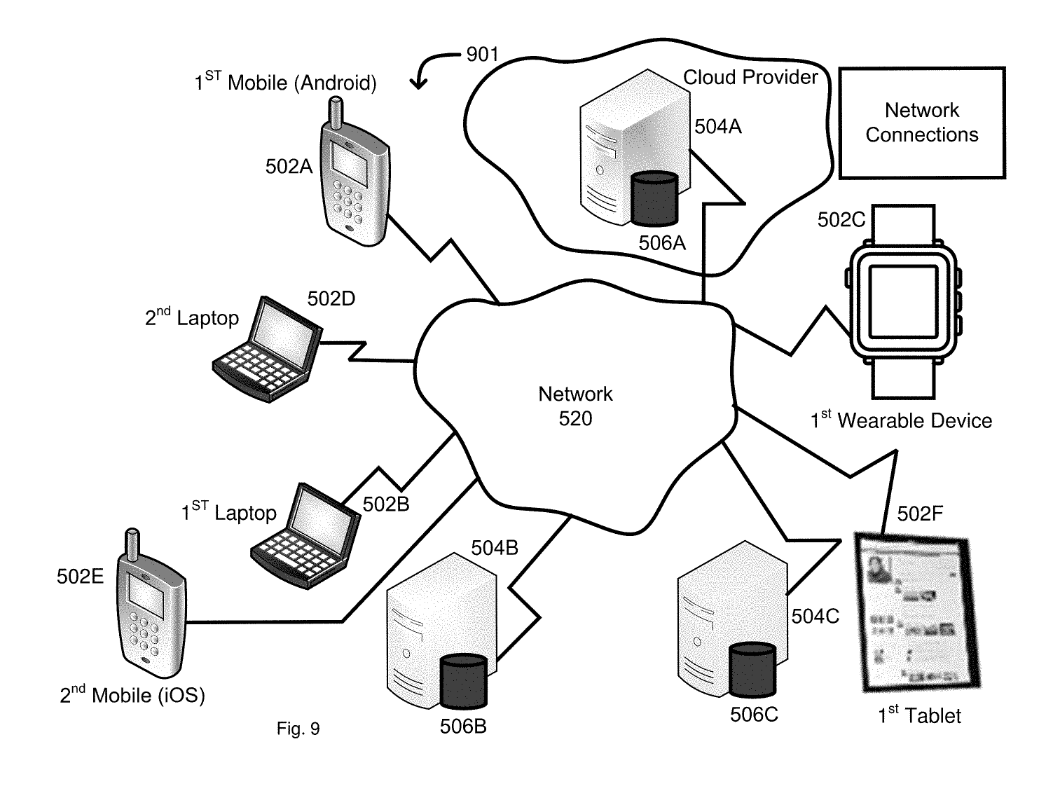

FIG. 9 illustrates a diagram of an embodiment of the on-line application that is coded to communicate and cooperate with an artificial intelligence engine as well as two or more mobile computing devices. A cloud platform with its one or more servers and one or more cooperating databases may host the on-line application and artificial intelligence engine.

Referring to FIG. 9, the on-line application can work with instances of the local mobile application, each instance on its own device 502A-502G that cooperates with an intelligence engine hosted on a server 504A acting a centralized intelligence.

In an embodiment, the on-line application is coded as a web application; and thus, agnostic to the operating systems of any of the mobile devices or desktop devices utilizing the web application. Merely a browser and a plug-in may be needed. In an embodiment, a local mobile application is resident on the mobile computing device and the local mobile application is configured to communicate and work with the operating system of that mobile computing device. The on-line application is coded to communicate with the artificial intelligence engine hosted on a server 504A and the local mobile application.

Each of the multiple electronic devices, such as smart phones 502A, 502E, tablet 502F, smart watch 502C, laptops 502B & 502D, and smart watch 504C, has a cooperating portion resident on that device. The on-line application is configured to send communications to each instance resident on another electronic device. The set of distributed portions of the on-line application resident on their respective electronic device 502A-502G are configured to periodically receive updates over a network from a backend server 504A hosted on a cloud platform to update the preprogrammed scenarios implemented with the conditional logic. The intelligence engine may also aggregate user activity across all devices as well as what the population of users are doing.

In an embodiment, the on-line application and intelligence engine are hosted on a cloud platform with one or more servers 504A cooperating with one or more databases 506A. One or more of the servers 504A on the cloud platform interact with the set of multiple electronic devices 502A-502G acting as client devices. The on-line application cooperates with the intelligence engine that is hosted on a cloud platform and cooperates over a network with one or more of the client electronic devices 502A-502G, through a browser application or directly interacting with a cooperating application resident on the client electronic device. One or more of these multiple electronic devices, such as the laptop 502D, tablet 502F, etc., have one or more sensors.

The one or more example sensors may include i) a Bluetooth sensor and circuit, ii) a Near Field Communication sensor and circuit, iii) a camera, iv) a global positioning system module with an elevation sensor, v) similar sensors, and vi) any combination of these.

The intelligence engine hosted on a cloud platform with one or more servers 504A cooperates with its set of one or more databases 506A. The artificial intelligence engine reviews the data recorded in the digital checklist. A reference database stores the historical recorded digital checklists. The artificial intelligence engine analyzes completed digital checklists to ensure they were performed within normal parameters. The artificial intelligence engine ensures compliance with the steps of the digital checklist via use of time stamps and performing comparing new data to historical averages. The artificial intelligence engine also looks at the data to perform trend analysis on the change in data values and make predictions about maintenance and potential repair of equipment in the building such as a datacenter. The artificial intelligence engine can then certify that procedures were properly performed in the digital checklist. The artificial intelligence engine also ensures actual completion of each step in the digital checklist is completed. Increased application of the artificial intelligence engine allows the system to become more predictive when it comes to preventing failures and ensuring proper completion.

One or more of the servers on the cloud platform interact and communicate directly with the set of client devices 502A-502G over a communications network 520. The network 520 can include one or more networks selected from an optical network, a cellular network, the Internet, a Local Area Network (LAN), a Wide Area Network (WAN), a satellite network, a fiber network, a cable network, and combinations thereof. In some embodiments, the communications network 520 is the Internet. As shown, there may be many server computing systems and many client computing systems connected to each other via the communications network 520. However, it should be appreciated that, for example, a single client computing system can also be connected to a single server computing system. As such, FIG. 9 illustrates any combination of server computing systems and client computing systems connected to each other via the communications network 520.

Overall, the communications network 520 can connect one or more server computing systems selected from at least a first server computing system 504A and a second server computing system 504B to each other and to at least one or more client computing systems as well. The server computing systems 504A and 504B can respectively optionally include organized data structures such as databases 506A and 506B. Each of the one or more server computing systems can have one or more virtual server computing systems, and multiple virtual server computing systems can be implemented by design. Each of the one or more server computing systems can have one or more firewalls to protect data integrity.

The client computing systems can be selected from a first mobile computing device 502A (e.g., smartphone with an Android-based operating system), a second mobile computing device 502E (e.g., smartphone with an iOS-based operating system), a first wearable electronic device 502C (e.g., a smart watch), a first portable computer 502B (e.g., laptop computer), a third mobile computing device or second portable computer 502D (e.g., tablet with an Android- or iOS-based operating system), firewalls to protect data integrity. Note, in an embodiment, a mobile computing device may encompass all of the client computing systems above.

It should be appreciated that the use of the terms “client computing system” and “server computing system” is intended to indicate the system that generally initiates a communication and the system that generally responds to the communication. For example, a client computing system can generally initiate a communication and a server computing system generally responds to the communication. No hierarchy is implied unless explicitly stated. Both functions can be in a single communicating system or device, in which case, the client-server and server-client relationship can be viewed as peer-to-peer. Thus, if the first mobile computing device 502A (e.g., the client computing system) and the server computing system 504A can both initiate and respond to communications, their communications can be viewed as peer-to-peer. Likewise, communications between the one or more server computing systems (e.g., server computing systems 504A and 504B) and the one or more client computing systems (e.g., client computing systems 502A and 502C) can be viewed as peer-to-peer if each is capable of initiating and responding to communications. Additionally, the server computing systems 504A and 504B include circuitry and software enabling communication with each other across the network 520.

Any one or more of the server computing systems can be included a cloud provider platform. A cloud provider can install and operate application software in a cloud (e.g., the network 520 such as the Internet) and cloud users can access the application software from one or more of the client computing systems. Generally, cloud users that have a cloud-based site in the cloud cannot solely manage a cloud infrastructure or platform where the application software runs. Thus, the server computing systems and organized data structures thereof can be shared resources, where each cloud user is given a certain amount of dedicated use of the shared resources. Each cloud user's cloud-based site can be given a virtual amount of dedicated space and bandwidth in the cloud. Cloud applications can be different from other applications in their scalability, which can be achieved by cloning tasks onto multiple virtual machines at run-time to meet changing work demand. Load balancers distribute the work over the set of virtual machines. This process is transparent to the cloud user, who sees only a single access point.

Cloud-based remote access can be coded to utilize a protocol, such as Hypertext Transfer Protocol (HTTP), to engage in a request and response cycle with an application on a client computing system such as a mobile computing device application resident on the mobile computing device as well as a web-browser application resident on the mobile computing device. The cloud-based remote access can be accessed by a smartphone, a desktop computer, a tablet, or any other client computing systems, anytime and/or anywhere. The cloud-based remote access is coded to engage in 1) the request and response cycle from all web browser based applications, 2) SMS/twitter-based requests and responses message exchanges, 3) the request and response cycle from a dedicated on-line server, 4) the request and response cycle directly between a native mobile application resident on a client device and the cloud-based remote access to another client computing system, and 5) combinations of these.

In an embodiment, the server computing system 504A can include a server engine, a web page management component, a content management component, and a database management component. The server engine can perform basic processing and operating system level tasks. The web page management component can handle creation and display or routing of web pages or screens associated with receiving and providing digital content and digital advertisements. Users (e.g., cloud users) can access one or more of the server computing systems by means of a Uniform Resource Locator (URL) associated therewith. The content management component can handle most of the functions in the embodiments described herein. The database management component can include storage and retrieval tasks with respect to the database, queries to the database, and storage of data.

An embodiment of a server computing system to display information, such as a web page, etc. is discussed. An application including any program modules, services, processes, and other similar software executable when executed on, for example, the server computing system 504A, causes the server computing system 504A to display windows and user interface screens on a portion of a media space, such as a web page. A user via a browser from, for example, the client computing system 502A, can interact with the web page, and then supply input to the query/fields and/or service presented by a user interface of the application. The web page can be served by a web server, for example, the server computing system 504A, on any Hypertext Markup Language (HTML) or Wireless Access Protocol (WAP) enabled client computing system (e.g., the client computing system 502A) or any equivalent thereof. F or example, the client mobile computing system 502A may be a wearable electronic device, a smartphone, a tablet, a laptop, a netbook, etc. The client computing system 502A can host a browser, a mobile application, and/or a specific application to interact with the server computing system 504A. Each application has a code scripted to perform the functions that the software component is coded to carry out such as presenting fields and icons to take details of desired information. Algorithms, routines, and engines within, for example, the server computing system 504A can take the information from the presenting fields and icons and put that information into an appropriate storage medium such as a database (e.g., database 506A). A comparison wizard can be scripted to refer to a database and make use of such data. The applications may be hosted on, for example, the server computing system 504A and served to the browser of, for example, the client computing system 502A. The applications then serve pages that allow entry of details and further pages that allow entry of more details.

The cloud platform contains one or more non-transitory storage mediums, such as memories, containing data and instructions to be executed by one or more processors for the digital checklist presented by the graphical user interface of the on-line application. Portions of the on-line application implemented in software are stored in one or more of the non-transitory storage mediums.

Businesses placing a high value on forced step compliance with company procedures also value the fact that the on-line application uses the artificial intelligence engine to look for deviations in the data collected from historical averages for data collected within that step of a digital checklist or procedure, which in turn ensures that it was in fact completed rather than filled in pseudo data. A significant feature is that on-line application uses the artificial intelligence engine to look at the digital checklist step completion times and then compare those to baseline and accumulated data to flag anomalies in a digital checklist completion. In effect, data from a digital checklist can be graphed with times for each step and then have a curve on that graph that represents normal completion. Deviations from the expected data past a threshold deviation amount will be identified by the artificial intelligence engine and then report out to appropriate/designated person at the company. For example, if a worker does not actually perform the required actions called for in the digital checklist and attempts to trick the system, the curve generated by the fraudulent attempt will not match the measured curve in the system and will be flagged for review. This drives compliance, and ensures critical procedures are properly performed.

The on-line application cooperating with the local mobile application provides a complete solution, including software, mobile technology, and online tools and consulting. The system helps a company's team to achieve precise, error-free operations. The system will enhance compliance by ensuring mobile access to consistently updated procedures, while providing overview via comprehensive leadership dashboards.

The checklist database stores data and has multiple conversion routines to allow all data collected in the system to be exported to other systems for additional reporting and analytics. The on-line application cooperating with the backend servers may output data to report to many big data systems. The on-line application cooperating with the backend servers may also build out a volume model in an effort to provide this high level of sophisticated operations to a large number of small enterprises at a low price/high volume model.

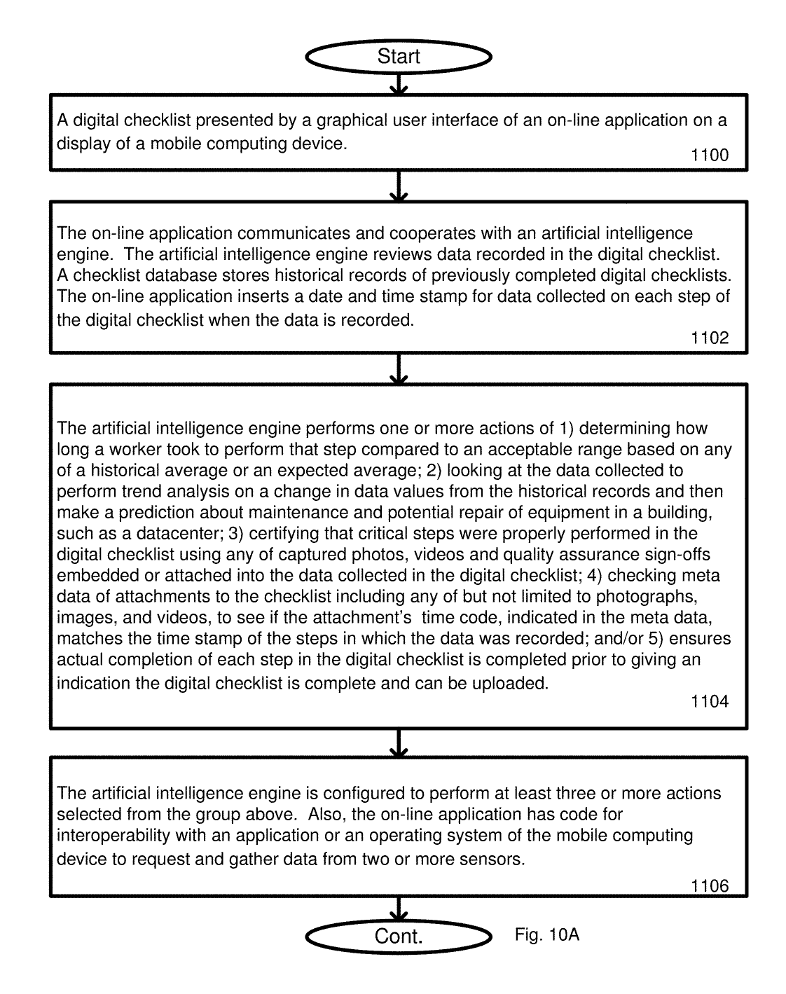

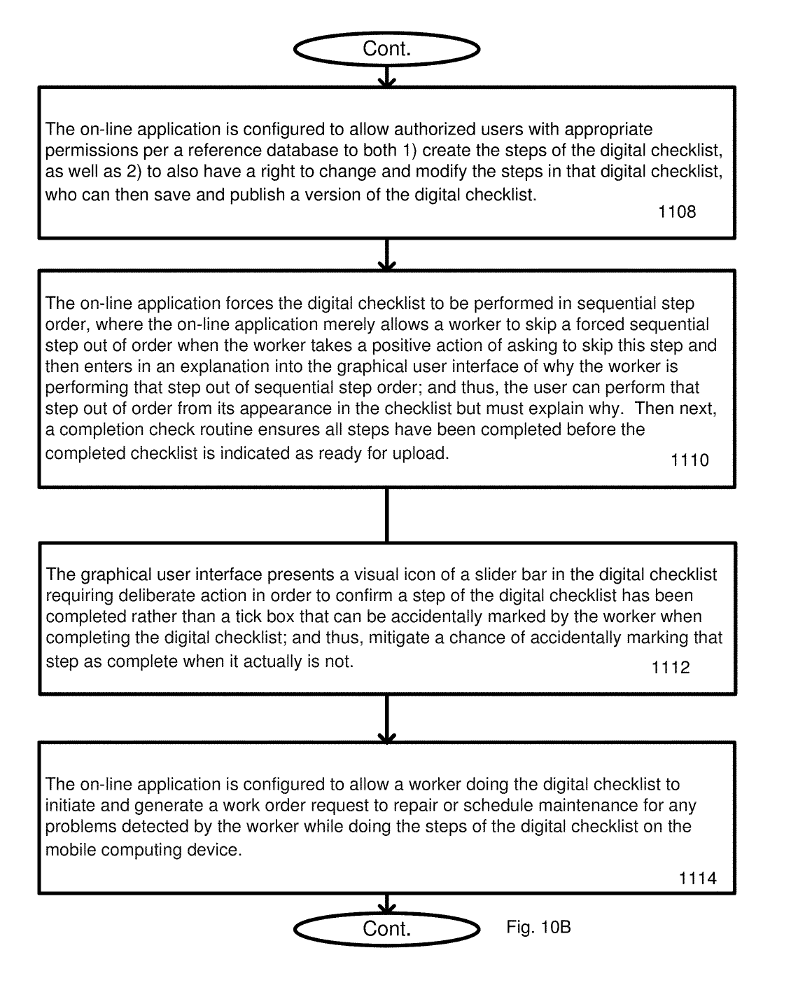

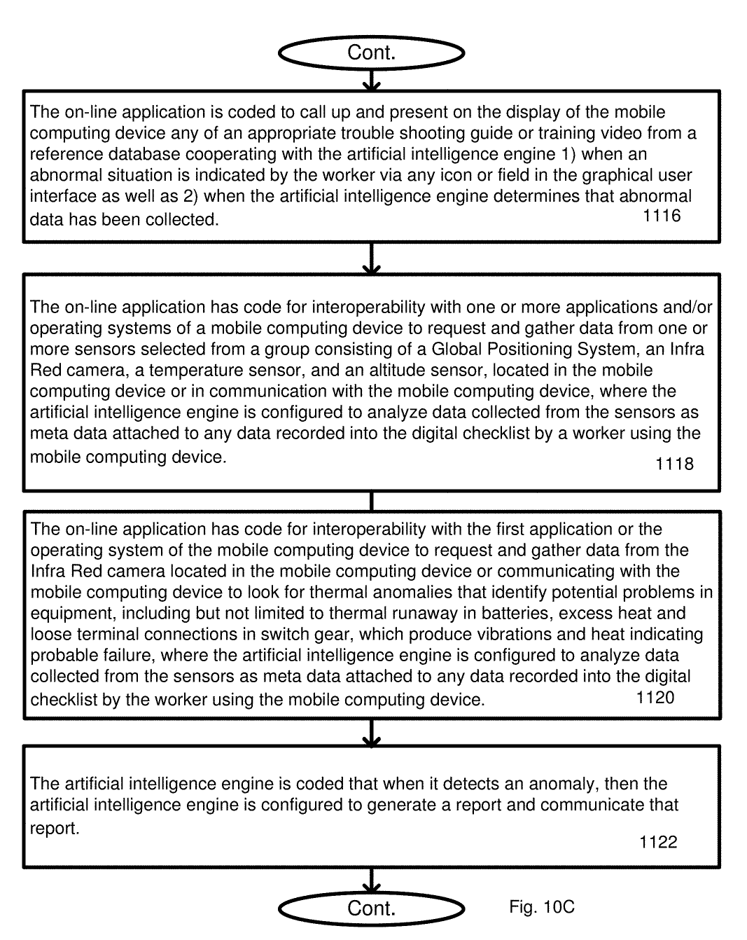

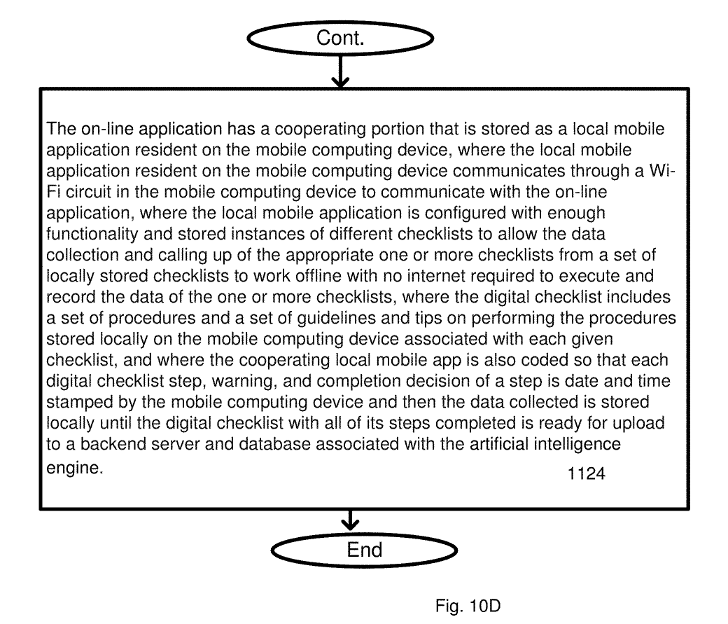

FIGS. 10A-10D illustrate a flow diagram of an embodiment of a method for a digital checklist presented by a graphical user interface of an on-line application on a display of a mobile computing device. The below steps are an example method. The steps may be performed out of order, some steps not performed at all, and some additional steps added in. An example method for a digital checklist presented by a graphical user interface of an on-line application on a display of a mobile computing device may be as follows.

In step 1102, the on-line application communicates and cooperates with an artificial intelligence engine. The artificial intelligence engine reviews data recorded in the digital checklist. A checklist database stores historical records of previously completed digital checklists. The on-line application inserts a date and time stamp for data collected on each step of the digital checklist when the data is recorded.

In step 1104, the artificial intelligence engine performs one or more actions of 1) determining how long a worker took to perform that step compared to an acceptable range based on any of a historical average or an expected average; 2) looking at the data collected to perform trend analysis on a change in data values from the historical records and then make a prediction about maintenance and potential repair of equipment in a building, such as a datacenter; 3) certifying that critical steps were properly performed in the digital checklist using any of captured photos, videos and quality assurance sign-offs embedded or attached into the data collected in the digital checklist; 4) checking meta data of attachments to the checklist including any of but not limited to photographs, images, and videos, to see if the attachment's time code, indicated in the meta data, matches the time stamp of the steps in which the data was recorded; and/or 5) ensures actual completion of each step in the digital checklist is completed prior to giving an indication the digital checklist is complete and can be uploaded.

In step 1106, the on-line application is configured to communicate and cooperate with an artificial intelligence engine, where the artificial intelligence engine is configured to perform at least three or more actions selected from the group consisting of 1) determining how long a worker took to perform that step compared to an acceptable range based on any of a historical average or expected average; 2) looking at the data collected to perform trend analysis on a change in data values from the historical records and then make a prediction about maintenance and potential repair of equipment in a building, such as a datacenter; 3) certifying that critical steps were properly performed in the digital checklist using any of captured photos, videos and quality assurance sign-offs embedded or attached into the data collected in the digital checklist; 4) checking meta data of attachments to the checklist including any of but not limited to photographs, images, and videos, to see if the attachment's time code, indicated in the meta data, matches the time stamp of the steps in which the data was recorded; and/or 5) ensures actual completion of each step in the digital checklist is completed prior to giving the indication the digital checklist is complete and can be uploaded, where the on-line application has code for interoperability with an application or an operating system of the mobile computing device to request and gather data from two or more sensors selected from the group consisting of the Global Positioning System, the Infrared camera, the temperature sensor, and the altitude sensor, located in the mobile computing device or communicating with the mobile computing device, where the artificial intelligence engine is configured to analyze the data collected from the sensors attached as the meta data to any data recorded into the digital checklist by the worker.

In step 1108, the on-line application is configured to allow authorized users with appropriate permissions per a reference database to both 1) create the steps of the digital checklist, as well as 2) to also have a right to change and modify the steps in that digital checklist, who can then save and publish a version of the digital checklist.

In step 1110, the on-line application forces the digital checklist to be performed in sequential step order, where the on-line application merely allows a worker to skip a forced sequential step out of order when the worker takes a positive action of asking to skip this step and then enters in an explanation into the graphical user interface of why the worker is performing that step out of sequential step order; and thus, the user can perform that step out of order from its appearance in the checklist. Then next, a completion check routine ensures all steps have been completed before the completed checklist is indicated as ready for upload.

In step 1112, the graphical user interface presents a visual icon of a slider bar in the digital checklist requiring deliberate action in order to confirm a particular step of the digital checklist has been completed rather than a tick box that can be accidentally marked by the worker when completing the digital checklist; and thus, mitigate a chance of accidentally marking a step as complete when it actually is not.

In step 1114, the on-line application is configured to allow a worker doing the digital checklist to initiate and generate a work order request to repair or schedule maintenance for any problems detected by the worker while doing the steps of the digital checklist on the mobile computing device.

In step 1116, the on-line application is coded to call up and present on the display of the mobile computing device any of an appropriate trouble shooting guide or training video from a reference database cooperating with the artificial intelligence engine 1) when an abnormal situation is indicated by the worker via any icon or field in the graphical user interface as well as 2) when the artificial intelligence engine determines that abnormal data has been collected.

In step 1118, the on-line application has code for interoperability with one or more applications and/or operating systems of a mobile computing device to request and gather data from one or more sensors selected from a group consisting of a Global Positioning System, an Infrared camera, a temperature sensor, and an altitude sensor, located in the mobile computing device or in communication with the mobile computing device, where the artificial intelligence engine is configured to analyze data collected from the sensors as meta data attached to any data recorded into the digital checklist by a worker using the mobile computing device.

In step 1120, the on-line application has code for interoperability with the first application or the operating system of the mobile computing device to request and gather data from the Infrared camera located in the mobile computing device or communicating with the mobile computing device to look for 1) thermal anomalies that identify potential problems in equipment, including but not limited to thermal runaway in batteries, and 2) excess heat from loose terminal connections in switch gear that produce vibrations and heat indicating probable failure, where the artificial intelligence engine is configured to analyze data collected from the sensors as meta data attached to any data recorded into the digital checklist by the worker using the mobile computing device.

In step 1122, the artificial intelligence engine is coded that when it detects an anomaly, then the artificial intelligence engine is configured to generate a report and communicate that report.

In step 1124, the on-line application has a cooperating portion that is stored as a local mobile application resident on the mobile computing device, where the local mobile application resident on the mobile computing device communicates through a Wi-Fi circuit in the mobile computing device to communicate with the on-line application, where the local mobile application is configured with enough functionality and stored instances of different checklists to allow the data collection and calling up of the appropriate one or more checklists from a set of locally stored checklists to work offline with no internet required to execute and record the data of the one or more checklists, where the digital checklist includes a set of procedures and a set of guidelines and tips on performing the procedures stored locally on the mobile computing device associated with each given checklist, and where the cooperating local mobile app is also coded so that each digital checklist step, warning, and completion decision of a step is date and time stamped by the mobile computing device and then the data collected is stored locally until the digital checklist with all of its steps completed is ready for upload to a backend server and database associated with the artificial intelligence engine.

While some specific embodiments of the invention have been shown, the invention is not to be limited to these embodiments. The invention is to be understood as not limited by the specific embodiments described herein, but only by scope of the appended claims.

1. A non-transitory storage medium containing data and instructions to be executed by one or more processors for a digital checklist presented by a graphical user interface of an on-line application on a display of a mobile computing device, comprising:
where the on-line application is coded to communicate and cooperate with an artificial intelligence engine, where the artificial intelligence engine is configured to review data recorded in the digital checklist, where a checklist database is configured to store historical records of previously completed digital checklists, where the on-line application is coded to insert a date and time stamp for data collected on two or more steps of the digital checklist when the data is recorded, where the artificial intelligence engine is configured to perform one or more actions selected from a group consisting of 1) determining how long a worker took to perform that step compared to an acceptable range based on any of a historical average or an expected average; 2) looking at the data collected to perform trend analysis on a change in data values from the historical records and then make a prediction about maintenance and potential repair of equipment in a building; 3) certifying that critical steps were properly performed in the digital checklist using any of captured photos, videos and quality assurance sign-offs embedded or attached into the data collected in the digital checklist; and 4) checking meta data of attachments to the digital checklist including any of but not limited to photographs, images, and videos, to see if the attachment's time code, indicated in the meta data, matches the time stamp of the steps in which the data was recorded; where the artificial intelligence engine is coded that when it detects an anomaly, then the artificial intelligence engine is configured to generate a report and communicate that report.

2. The non-transitory storage medium storing instructions and data for the on-line application of claim 1, where the graphical user interface is configured to present a visual icon of a slider bar in the digital checklist requiring deliberate action in order to confirm a particular step of the digital checklist has been completed rather than a tick box that can be accidentally marked by the worker when completing the digital checklist; and thus, mitigate a chance of accidentally marking the particular step as complete when it actually is not.

3. The non-transitory storage medium storing instructions and data for the on-line application of claim 1, where the on-line application is coded for interoperability with a first application or operating system of the mobile computing device to request and gather data from one or more sensors selected from a group consisting of a Global Positioning System, an Infrared camera, a temperature sensor, and an altitude sensor, located in the mobile computing device or in communication with the mobile computing device, where the artificial intelligence engine is configured to analyze data collected from the sensors as meta data attached to any data recorded into the digital checklist by the worker using the mobile computing device.

4. The non-transitory storage medium storing instructions and data for the on-line application of claim 3, where the on-line application is configured to communicate and cooperate with the artificial intelligence engine, where the artificial intelligence engine is configured to perform three or more actions selected from the group consisting of 1) determining how long the worker took to perform that step compared to the acceptable range based on any of the historical average or the expected average; 2) looking at the data collected to perform trend analysis on the change in data values from the historical records and then make the prediction about maintenance and potential repair of equipment in the building; 3) certifying that critical steps were properly performed in the digital checklist using any of captured photos, videos and quality assurance sign-offs embedded or attached into the data collected in the digital checklist; 4) checking meta data of attachments to the checklist including any of but not limited to photographs, images, and videos, to see if the attachment's time code, indicated in the meta data, matches the time stamp of the steps in which the data was recorded; and 5) ensuring actual completion of each step in the digital checklist is completed prior to giving the indication the digital checklist is complete and can be uploaded, where the on-line application has code for interoperability with the first application or the operating system of the mobile computing device to request and gather from two or more sensors selected from the group consisting of the Global Positioning System, the Infrared camera, the temperature sensor, and the altitude sensor, located in the mobile computing device or communicating with the mobile computing device, where the artificial intelligence engine is configured to analyze the data collected from the sensors attached as the meta data to any data recorded into the digital checklist by the worker using the mobile computing device.

5. The non-transitory storage medium storing instructions and data for the on-line application of claim 3, where the artificial intelligence engine is configured to perform two or more actions selected from the group consisting of 1) determining how long the worker took to perform that step compared to the acceptable range based on any of the historical average or the expected average; 2) looking at the data collected to perform trend analysis on the change in data values from the historical records and then make the prediction about maintenance and potential repair of equipment in the building; 3) certifying that critical steps were properly performed in the digital checklist using any of captured photos, videos and quality assurance sign-offs embedded or attached into the data collected in the digital checklist; 4) checking meta data of attachments to the checklist including any of but not limited to photographs, images, and videos, to see if the attachment's time code, indicated in the meta data, matches the time stamp of the steps in which the data was recorded; and 5) ensuring actual completion of each step in the digital checklist is completed prior to giving the indication the digital checklist is complete and can be uploaded; and
where the on-line application has code for interoperability with the first application or the operating system of the mobile computing device to request and gather data from the Infrared camera located in the mobile computing device or communicating with the mobile computing device to look for 1) thermal anomalies that identify potential problems in equipment, including but not limited to thermal runaway in batteries, and 2) excess heat from loose terminal connections in switch gear that produce vibrations and heat indicating probable failure, where the artificial intelligence engine is configured to analyze data collected from the sensors as meta data attached to any data recorded into the digital checklist by the worker using the mobile computing device.

6. The non-transitory storage medium storing instructions and data for the on-line application of claim 1, where the on-line application is configured to allow authorized users with appropriate permissions per a reference database to both 1) to create the steps of the digital checklist, as well as 2) to also have a right to change and modify the steps in that digital checklist, who can then save and publish a version of the digital checklist.

7. The non-transitory storage medium storing instructions and data for the on-line application of claim 1, where the on-line application is configured to have a cooperating portion that is stored as a local mobile application resident on the mobile computing device, where the local mobile application resident on the mobile computing device is configured to communicate through a Wi-Fi circuit in the mobile computing device to communicate with the on-line application, where the local mobile application is configured with enough functionality and stored instances of different checklists to allow the data collection and calling up of the appropriate one or more checklists from a set of locally stored checklists to work offline with no internet required to execute and record the data of the one or more checklists, where the digital checklist includes a set of procedures and a set of guidelines and tips on performing the procedures stored locally on the mobile computing device associated with each given checklist, and where the cooperating local mobile app is also coded so that each digital checklist step, warning, and completion decision of a step is date and time stamped by the mobile computing device and then the data collected is stored locally until the digital checklist with all of its steps completed is ready for upload to a backend server and database associated with the artificial intelligence engine.

8. The non-transitory storage medium storing instructions and data for the on-line application of claim 1, where the on-line application is configured to force the digital checklist to be performed in sequential step order, where the on-line application is configured to merely allow the worker to skip a forced sequential step out of order when the worker takes a positive action of asking to skip this step and then enters in an explanation into a field of the graphical user interface of why the worker is performing that step out of sequential step order; and thus, the user can perform that step out of order from its appearance in the checklist but must explain why, and where then a completion check routine ensures all steps have been completed before the completed checklist is indicated as ready for upload.

9. The non-transitory storage medium storing instructions and data for the on-line application of claim 1, where the on-line application is configured to allow the worker doing the digital checklist to initiate and generate a work order request to repair or schedule maintenance for any problems detected by the worker while doing the steps of the digital checklist on the mobile computing device.

10. The non-transitory storage medium storing instructions and data for the on-line application of claim 9, where the on-line application is coded to call up and present on the display of the mobile computing device any of an appropriate trouble shooting guide or training video from a reference database cooperating with the artificial intelligence engine 1) when an abnormal situation is indicated by the worker via any icon or field in the graphical user interface as well as 2) when the artificial intelligence engine determines that abnormal data has been collected.

11. A method for a digital checklist presented by a graphical user interface of an on-line application on a display of a mobile computing device, comprising:
where the on-line application communicates and cooperates with an artificial intelligence engine, where the artificial intelligence engine reviews data recorded in the digital checklist, where a checklist database stores historical records of previously completed digital checklists, where the on-line application insert a date and time stamp for data collected on two or more steps of the digital checklist when the data is recorded, where the artificial intelligence engine performs one or more actions selected from a group consisting of 1) determining how long a worker took to perform that step compared to an acceptable range based on any of a historical average or an expected average; 2) looking at the data collected to perform trend analysis on a change in data values from the historical records and then make a prediction about maintenance and potential repair of equipment in a building; 3) certifying that critical steps were properly performed in the digital checklist using any of captured photos, videos and quality assurance sign-offs embedded or attached into the data collected in the digital checklist; and 4) checking meta data of attachments to the checklist including any of but not limited to photographs, images, and videos, to see if the attachment's time code, indicated in the meta data, matches the time stamp of the steps in which the data was recorded; where the artificial intelligence engine is coded that when it detects an anomaly, then the artificial intelligence engine is configured to generate a report and communicate that report, where portions of the on-line application implemented in software is stored in one or more of the non-transitory storage mediums.

12. The method of claim 11, where the graphical user interface presents a visual icon of a slider bar in the digital checklist requiring deliberate action in order to confirm a first step of the digital checklist has been completed rather than a tick box that can be accidentally marked by the worker when completing the digital checklist; and thus, mitigate a chance of accidentally marking the first step as complete when it actually is not.

13. The method of claim 11, where the on-line application has code for interoperability with a first application or operating system of the mobile computing device to request and gather data from one or more sensors selected from a group consisting of a Global Positioning System, an Infrared camera, a temperature sensor, and an altitude sensor, located in the mobile computing device or in communication with the mobile computing device, where the artificial intelligence engine is configured to analyze data collected from the sensors as meta data attached to any data recorded into the digital checklist by the worker using the mobile computing device.

14. The method of claim 13, where the on-line application is configured to communicate and cooperate with an artificial intelligence engine, where the artificial intelligence engine is configured to perform three or more actions selected from the group consisting of 1) determining how long the worker took to perform that step compared to an acceptable range based on any of a historical average or expected average; 2) looking at the data collected to perform trend analysis on a change in data values from the historical records and then make a prediction about maintenance and potential repair of equipment in a building, such as a datacenter; 3) certifying that critical steps were properly performed in the digital checklist using any of captured photos, videos and quality assurance sign-offs embedded or attached into the data collected in the digital checklist; 4) checking meta data of attachments to the checklist including any of but not limited to photographs, images, and videos, to see if the attachment's time code, indicated in the meta data, matches the time stamp of the steps in which the data was recorded; and 5) ensures actual completion of each step in the digital checklist is completed prior to giving the indication the digital checklist is complete and can be uploaded, where the on-line application has code for interoperability with the first application or the operating system of the mobile computing device to request and gather data from two or more sensors selected from the group consisting of the Global Positioning System, the Infrared camera, the temperature sensor, and the altitude sensor, located in the mobile computing device or communicating with the mobile computing device, where the artificial intelligence engine is configured to analyze the data collected from the sensors attached as meta data to any data recorded into the digital checklist by the worker.

15. The method of claim 13, where the artificial intelligence engine is configured to perform two or more actions selected from the group consisting of 1) determining how long the worker took to perform that step compared to the acceptable range based on any of the historical average or the expected average; 2) looking at the data collected to perform trend analysis on the change in data values from the historical records and then make the prediction about maintenance and potential repair of equipment in the building; 3) certifying that critical steps were properly performed in the digital checklist using any of captured photos, videos and quality assurance sign-offs embedded or attached into the data collected in the digital checklist; 4) checking meta data of attachments to the checklist including any of but not limited to photographs, images, and videos, to see if the attachment's time code, indicated in the meta data, matches the time stamp of the steps in which the data was recorded; and 5) ensuring actual completion of each step in the digital checklists/procedure is completed prior to giving the indication the digital checklist is complete and can be uploaded; and
where the on-line application has code for interoperability with the first application or the operating system of the mobile computing device to request and gather data from the Infrared camera located in the mobile computing device or communicating with the mobile computing device to look for 1) thermal anomalies that identify potential problems in equipment, including but not limited to thermal runaway in batteries, and 2) excess heat from loose terminal connections in switch gear that produce vibrations and heat indicating probable failure, where the artificial intelligence engine is configured to analyze data collected from the sensors as meta data attached to any data recorded into the digital checklist by the worker using the mobile computing device.

16. The method of claim 11, where the on-line application is configured to allow authorized users with appropriate permissions per a reference database to both 1) create the steps of the digital checklist, as well as 2) to also have a right to change and modify the steps in that digital checklist, who can then save and publish a version of the digital checklist.

17. The method of claim 11, where the on-line application has a cooperating portion that is stored as a local mobile application resident on the mobile computing device, where the local mobile application resident on the mobile computing device communicates through a Wi-Fi circuit in the mobile computing device to communicate with the on-line application, where the local mobile application is configured with enough functionality and stored instances of different checklists to allow the data collection and calling up of the appropriate one or more checklists from a set of locally stored checklists to work offline with no internet required to execute and record the data of the one or more checklists, where the digital checklist includes a set of procedures and a set of guidelines and tips on performing the procedures stored locally on the mobile computing device associated with each given checklist, and where the cooperating local mobile app is also coded so that each digital checklist step, warning, and completion decision of a step is date and time stamped by the mobile computing device and then the data collected is stored locally until the digital checklist with all of its steps completed is ready for upload to a backend server and database associated with the artificial intelligence engine.

18. The method of claim 11, where the on-line application forces the digital checklist to be performed in sequential step order, where the on-line application merely allows the worker to skip a forced sequential step out of order when the worker takes a positive action of asking to skip this step and then enters in an explanation into the graphical user interface of why the worker is performing that step out of sequential step order; and thus, the user can perform that step out of order from its appearance in the checklist but must explain why, and where then a completion check routine ensures all steps have been completed before the completed checklist is indicated as ready for upload.

19. The method of claim 11, where the on-line application is configured to allow the worker doing the digital checklist to initiate and generate a work order request to repair or schedule maintenance for any problems detected by the worker while doing the steps of the digital checklist on the mobile computing device.

20. The method of claim 19, where the on-line application is coded to call up and present on the display of the mobile computing device any of an appropriate trouble shooting guide or training video from a reference database cooperating with the artificial intelligence engine 1) when an abnormal situation is indicated by the worker via any icon or field in the graphical user interface as well as 2) when the artificial intelligence engine determines that abnormal data has been collected.
